(19) United States
(12) Patent Application Publication
(10) Pub. No.: US 2007/0259160 A1
(43) Pub. Date: Nov. 8, 2007

(54) Circuit board with heat radiating sheet

(75) Inventor: Yu Li Huang, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: INSIGHT ELECTRONIC GROUP INC.

(21) Appl. No.: 11/593,631

(22) Filed: Nov. 7, 2006

(30) Foreign Application Priority Data
May 5, 2006 (TW) 95207710

(51) Int. Cl. B32B 3/00

(52) U.S. Cl. 428/209; 428/901

(57) ABSTRACT

A circuit board has a copper foil layer provided on one side thereof, a tin layer provided on a top of the copper foil layer, and a heat radiating sheet provided on the tin layer. When the circuit board is processed in a reflow oven, the tin layer is melted to associate with the copper foil layer and the heat radiating sheet. High amount of heat produced by electronic elements mounted on the circuit board during operation thereof is absorbed by the copper foil layer and then transmitted to the tin layer, which quickly transfers the absorbed heat to the heat radiating sheet that has a large radiating area, so that the heat is more quickly dissipated into air. A heat pipe may be embedded in the tin layer to enhance the radiating efficiency, so that the electronic elements on the circuit board always have a normal operating temperature.

### FIELD OF THE INVENTION

The present invention relates to a circuit board with heat radiating sheet, and more particularly to a circuit board being provided with a tin layer on a copper foil layer thereof, and a heat radiating sheet and/or a heat pipe associated with the tin layer to provide increased heat dissipating area, so that heat produced by electronic elements mounted on the circuit board could be more quickly transferred to and dissipated from the heat radiating sheet into air.

### BACKGROUND OF THE INVENTION

Circuit boards have wide applications in different fields. Electronic elements in most electronic products are mounted on a circuit board. Some of these electronic elements are high-power elements to produce high amount of heat during operation thereof. Therefore, currently available circuit boards are usually enhanced in design to enable quick heat dissipation therefrom.

In the past, since only a small number of low power consumption electronic elements are mounted on a conventional circuit board, most of the heat produced by the electronic elements during operation is transmitted to a copper foil layer on the circuit board and dissipated into air therefrom. However, the nowadays circuit boards have a large number of high-power electronic elements mounted thereon. With the increased current supplied to the electronic elements, the power consumed by the electronic elements is increased at the same time to result in very high temperature at some areas on the circuit boards. The high amount of heat produced by the large quantity of high-power electronic elements on a circuit board could not be completely radiated simply via conductive contact pins provided on the electronic elements, and the circuit board and the electronic elements fail to maintain at normal operating temperatures. Exceeded operating temperatures would result in changes in the physical properties of the electronic elements to adversely affect the working performance, and risks of burnout and shortened service life of the electronic elements.

The currently available circuit boards, either single-layer or multilayer circuit boards, do not include any heat radiating structure. When an electronic element that would produce high amount of heat, such as a central processing unit or a North Bridge chipset, is mounted on a circuit board, a metal radiating sheet, preferably made of aluminum or copper, has to be added to the electronic element while using a thermal paste or a thermal tape as a conductive medium. Due to the metal property of the heat radiating sheets, the heat produced by the electronic elements may be quickly transmitted to and dissipated from the heat radiating sheets, so that the circuit board and the electronic elements may be effectively maintained at their normal operating temperatures.

There is a commercially available aluminum substrate with pretty good heat dissipation effect and suitable for use with heat-producing electronic elements. The aluminum substrate includes a copper foil layer, an aluminum sheet, and an adhesive sheet located between the copper foil layer and the aluminum sheet. When the three layers are compressed and laminated, the adhesive sheet is firmly connected to the copper foil layer and the aluminum sheet to form the aluminum substrate. When the electronic elements mounted on the aluminum substrate produce heat, the produced heat is transmitted to the aluminum sheet via the copper foil layer. The metal property of the aluminum sheet allows the heat transmitted thereto to dissipate into air.

However, either the conventional circuit board or the above-described aluminum substrate has many disadvantages in terms of the manufacture and use thereof:
1. While the metal heat radiating sheets are added to the electronic elements on the conventional circuit board in an attempt to enhance the dissipation of the produced heat, these metal heat radiating sheets also increase the overall manufacturing cost of the circuit board. Moreover, these metal radiating sheets have a large volume to cause inconveniences in assembling them to the circuit board, and there might not be enough space on the circuit board to accommodate these metal radiating sheets.
2. The heat radiating effect of the aluminum sheet is determined by its thickness. The conventional aluminum substrate usually has an overall thickness of 1.6 mm, which is too small to effectively remove the heat produced by the electronic elements and chipsets from the circuit board.
3. For the conventional circuit board and the metal heat radiating sheets provided thereto to ideally contact with each other, a thermal paste is provided between them to serve as a good conductor. However, the thermal paste has a heat conducting efficiency lower than that of metals, and tends to cure and deteriorate to form a thermal resistance, which disadvantageously results in lowered heat conducting efficiency thereof.

It is therefore an important issue in the electronic industry to develop a circuit board having even better heat dissipating ability.

### SUMMARY OF THE INVENTION

A primary object of the present invention is to provide a circuit board with heat radiating sheet. The heat radiating sheet is associated with the circuit board via a tin layer when the circuit board is processed in a reflow oven. With the good metal properties of tin, heat produced by the electronic elements mounted on the circuit board during operation thereof can be quickly transferred via the tin layer to the heat radiating sheet and dissipated into air, so that the circuit board has enhanced heat dissipating efficiency.

Another object of the present invention is to provide a circuit board with heat radiating sheet. The heat radiating sheet is formed with a plurality of fins to largely increase the heat radiating area and efficiency thereof, so that heat produced by the electronic elements mounted on the circuit board during operation thereof can be more quickly dissipated from the heat radiating sheet into air to effectively keep the electronic elements at normal operating temperature.

A further object of the present invention is to provide a circuit board with heat radiating sheet, so as to save the time and reduce the cost that are otherwise needed to provide the electronic elements on the circuit board with separate heat radiating sheets.

To achieve the above and other objects, the circuit board with heat radiating sheet according to the present invention includes a circuit board having a copper foil layer provided on one side thereof, and a tin layer provided on the top of the copper foil layer, and a heat radiating sheet associated with the tin layer.

In an embodiment of the present invention, the circuit board is a single-layer circuit board.

In another embodiment of the present invention, the circuit board is a multilayer circuit board.

In a preferred embodiment of the present invention, the circuit board is a flexible printed circuit board.

In another embodiment of the present invention, the circuit board is a high thermal conductive circuit board.

In an operable embodiment of the present invention, the heat radiating sheet may be made of a copper material, an iron material, an aluminum material, or other suitable metal materials, so as to provide enhanced heat radiating efficiency. In the case of an aluminum heat radiating sheet, it must be plated on outer surfaces with a layer of nickel to enable good association with the tin layer.

Moreover, a heat pipe may be embedded in the tin layer.

On the circuit board of the present invention, there are mounted a plurality of electronic elements or light emitting diodes.

When the circuit board of the present invention is in use, the electronic elements mounted on the circuit board produce high amount of heat during operation thereof. The heat produced by the electronic elements is directly absorbed by the copper foil layer and then quickly transferred via the tin layer to the heat radiating sheet. Since the heat radiating sheet provides a large heat radiating surface area, heat transferred thereto can be quickly dissipated into air to ensure that the electronic elements and the circuit board are kept at normal operating temperature without becoming overheated, and can therefore have extended service life. Moreover, the time and labor costs for adding separate heat radiating sheets to the electronic elements can be saved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a sectioned side view of a circuit board with heat radiating sheet according to a first embodiment of the present invention;

FIG. 2 is an exploded view of FIG. 1;

FIG. 3 is a sectioned side view showing an example of application of the circuit board of FIG. 1;

FIG. 4 is a sectioned side view of a circuit board with heat radiating sheet according to a second embodiment of the present invention;

FIG. 5 is a sectioned side view of a circuit board with heat radiating sheet according to a third embodiment of the present invention; and

FIG. 6 is a sectioned side view of a circuit board with heat radiating sheet according to a fourth embodiment of the present invention.

### DETAILED DESCRIPTION OF THE PREFERRED EMBODIMENTS

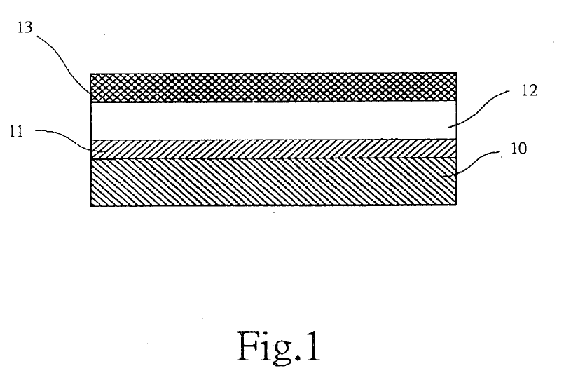

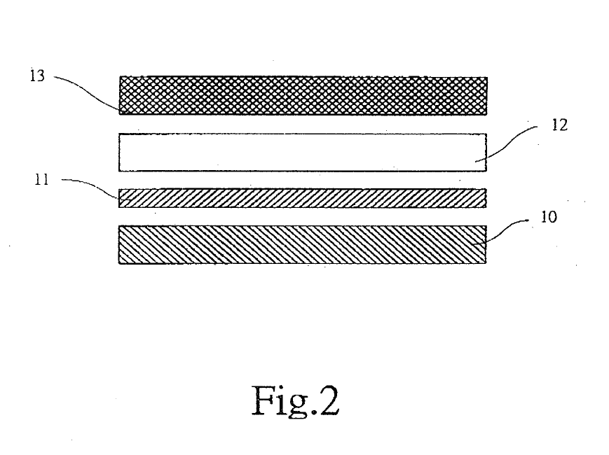

Please refer to FIGS. 1 and 2 that are assembled and exploded sectioned side views, respectively, of a circuit board with heat radiating sheet according to a first embodiment of the present invention. As shown, the first embodiment of the present invention includes a circuit board 10, a copper foil layer 11 formed on one surface of the circuit board 10, a tin layer 12 provided on a top of the copper foil layer 11, and a heat radiating sheet 13 associated with the tin layer 12.

The heat radiating sheet 13 may be made of a copper material, an iron material, or other suitable metal materials to enable enhanced heat conducting efficiency. When the heat radiating sheet 13 is made of an aluminum material, a layer of nickel must be plated on outer surfaces of the heat radiating sheet 13 to enable association of the aluminum material with the tin layer 12.

In one embodiment of the present invention, the circuit board 10 is a single-layer circuit board.

In another embodiment of the present invention, the circuit board 10 is a multilayer circuit board.

In a further embodiment of the present invention, the circuit board 10 is a flexible printed circuit board (FPC) 30.

In a still further embodiment of the present invention, the circuit board 10 is a high thermal conductive circuit board.

In manufacturing the circuit board according to the first embodiment of the present invention, the tin layer 12 is provided on a top of the copper foil layer 11 of the circuit board 10, and the heat radiating sheet 13 is superposed on the tin layer 12. The completed structure is then processed in a reflow oven to melt the tin layer 12, so that the heat radiating sheet 13 and the copper foil layer 11 may easily associate with the molten tin. When the molten tin has become cold, the heat radiating sheet 13 is fixed to the tin layer 12 to complete the circuit board of the present invention.

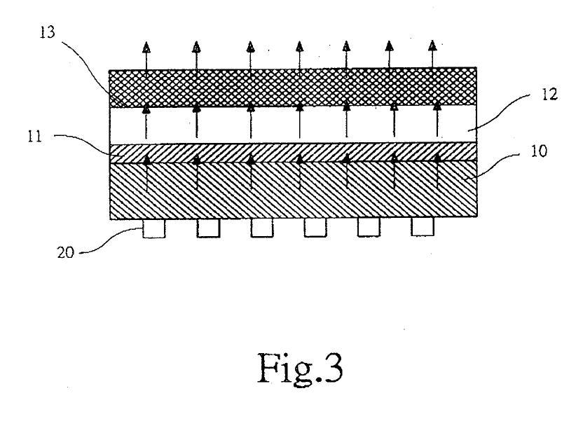

FIG. 3 shows an example of application of the circuit board 10 according to the first embodiment of the present invention. As shown, the circuit board 10 is provided on one side opposite to the side with the copper foil layer 11 with a plurality of electronic elements 20. These electronic elements 20 produce heat when being supplied with current, and the produced heat is transferred from the circuit board 10 to the copper foil layer 11. With the good metal properties of the tin layer 12, heat is quickly transferred from the copper foil layer 11 to the heat radiating sheet 13 via the tin layer 12, so that the produced heat is quickly dissipated into air from the heat radiating sheet 13.

The electronic elements 20 may be light emitting diodes. In this case, the light emitting diodes 20 produce heat when they emit light, and the produced heat is quickly transferred from the circuit board 10 to the tin layer 12 and the heat radiating sheet 13 above the copper foil layer 11, and quickly dissipated into air from the heat radiating sheet 13.

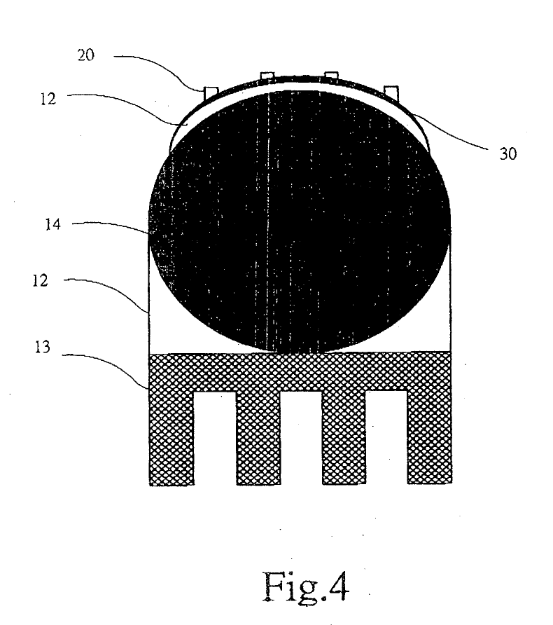

FIG. 4 shows a circuit board with heat radiating sheet according to a second embodiment of the present invention. In the second embodiment, the circuit board is a flexible circuit board 30, on one side of which there is applied a first tin layer 12. The first tin layer 12 is then superposed on a heat pipe 14 for the flexible circuit board 30 to fully attach to the heat pipe 14. The heat pipe 14 is provided at remaining surface areas with a second tin layer 12, and a heat radiating sheet 13 with a plurality of fins is attached to an outer side of the second tin layer 12. The above structure is then processed in a reflow oven, so that the tin layers 12 are molten to easily associate with the flexible circuit board 30 as well as the heat pipe 14 and the heat radiating sheet 13.

A plurality of electronic elements 20 may be mounted on the flexible circuit board 30. These electronic elements 20 produce heat during operation thereof, and the produced heat is transferred from the circuit board 10 to the associated tin layers 12, heat radiating sheet 13, and heat pipe 14 and rapidly dissipated into air. Heat may be quickly transferred from the heat pipe 14 to the heat radiating sheet 13. With the plurality of fins formed thereon, the heat radiating sheet 13 has a largely upgraded overall heat radiating efficiency to more quickly dissipate the heat into air, so that the heat produced by the electronic elements 20 may be effectively carried away.

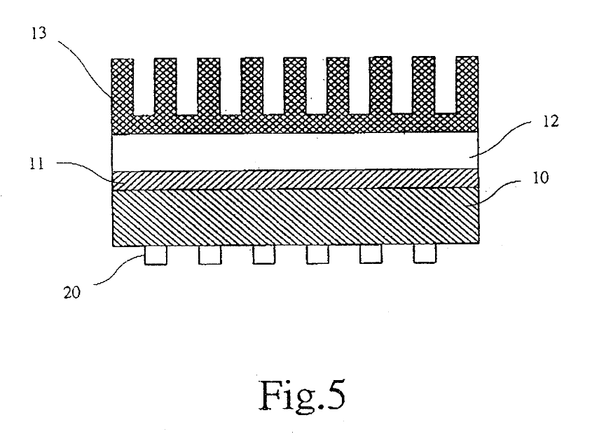

FIG. 5 shows a circuit board with heat radiating sheet according to a third embodiment of the present invention. The third embodiment is generally structurally similar to the first embodiment, except that the heat radiating sheet 13 includes a plurality of three-dimensional radiating fins formed on an outer side thereof, so that the heat radiating sheet 13 has largely increased radiating area and efficiency to very effectively dissipate heat from the circuit board 10.

With the large number of radiating fins formed on the heat radiating sheet 13, and the correspondingly increased radiating area and efficiency of the heat radiating sheet 13, heat absorbed by the copper foil layer 11 and transferred to the finned radiating sheet 13 could be more quickly dissipated into air to effectively remove the heat produced by the electronic elements 20 during operation thereof.

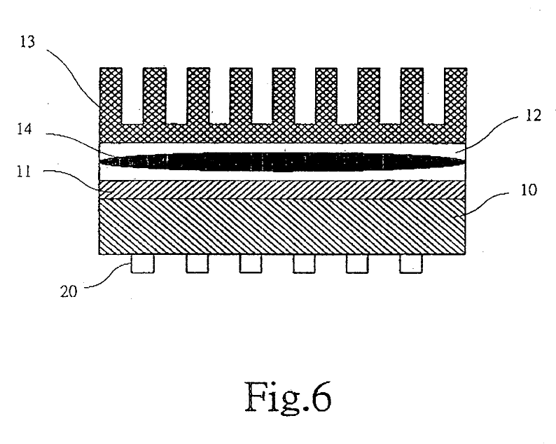

FIG. 6 shows a circuit board with heat radiating sheet according to a fourth embodiment of the present invention. The fourth embodiment is generally structurally similar to the third embodiment, except for a heat pipe 14 embedded in the tin layer 12. It is a property of the heat pipe 14 to quickly transfer heat to a low-temperature area. Therefore, with the heat pipe 14 embedded in the tin layer 12, heat produced by the electronic elements 20 and absorbed by the tin layer 12 could be more quickly transferred to and dissipated from the large radiating area of the finned heat radiating sheet 13 with higher radiating efficiency.

In manufacturing the circuit board of the present invention, since the tin layer 12 is molten in the reflow oven to firmly associate with the copper foil layer 11 and the heat radiating sheet 13, and since the tin layer 12 has good thermal conductive property, high amount of heat produced by the electronic elements 20 on the circuit board 10 during operation thereof could be quickly transferred via the tin layer 12 to the heat radiating sheet 13 and dissipated into air. When the radiating sheet 13 is formed with a plurality of fins to largely increase the radiating area, and the tin layer 12 has a heat pipe 14 embedded therein to increase the radiating efficiency, the electronic elements 20 may be kept at a normal operating temperature and have an extended service life. The time and labor cost for adding separate heat radiating sheets to the electronic elements on the circuit board can therefore be saved.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A circuit board with heat radiating sheet, comprising a circuit board having a copper foil layer provided on one side thereof, a tin layer provided on a top of said copper foil layer, and a heat radiating sheet associated with said tin layer to locate above said copper foil layer.

2. The circuit board with heat radiating sheet as claimed in claim 1, wherein said circuit board is a single-layer circuit board.

3. The circuit board with heat radiating sheet as claimed in claim 1, wherein said circuit board is a multilayer circuit board.

4. The circuit board with heat radiating sheet as claimed in claim 1, wherein said circuit board is a flexible printed circuit board.

5. The circuit board with heat radiating sheet as claimed in claim 1, wherein said heat radiating sheet is made of a copper material.

6. The circuit board with heat radiating sheet as claimed in claim 1, wherein said heat radiating sheet is made of an iron material.

7. The circuit board with heat radiating sheet as claimed in claim 1, wherein said heat radiating sheet is made of an aluminum material.

8. The circuit board with heat radiating sheet as claimed in claim 1, wherein said heat radiating sheet is made of a metal material.

9. The circuit board with heat radiating sheet as claimed in claim 7, wherein said heat radiating sheet made of an aluminum material is plated on outer surfaces with a layer of nickel to enable association of said aluminum heat radiating sheet with said tin layer via said nickel layer.

10. The circuit board with heat radiating sheet as claimed in claim 1, wherein said tin layer has a heat pipe embedded therein.
